(19) United States
(12) Patent Application Publication
(10) Pub. No.: US 2012/0128923 A1
(43) Pub. Date: May 24, 2012

(54) LAMINATE MATERIAL ELEMENT FOR A HOOK-AND-LOOP CLOSURE

(75) Inventors: Dieter HOMOELLE, Ochtrup (DE); Georg BALDAUF, Laer (DE)

(73) Assignee: NORDENIA TECHNOLOGIES GMBH, Gronau (DE)

(21) Appl. No.: 13/298,437

(22) Filed: Nov. 17, 2011

(30) Foreign Application Priority Data
Nov. 18, 2010 (EP) 10 191 766.4

(51) Int. Cl. B32B 3/06

(52) U.S. Cl. 428/86

(57) ABSTRACT

A laminate material element for a hook-and-loop closure, particularly for a diaper closure, having a carrier and a textile material laminated onto the carrier, which material has a basic structure formed from threads, and additional threads incorporated into the basic structure by means of knitting. The additional threads incorporated into the basic structure by means of knitting form loops provided for making a connection with hook-and-loop hooks. At least a part of the threads or fibers of the basic structure is formed from polyamide. According to the invention, the additional threads incorporated into the basic structure by means of knitting have polyolefin, particularly polypropylene, as their main component.

### CROSS REFERENCE TO RELATED APPLICATIONS

Applicants claim priority under 35 U.S.C. §119 of European Application No. 10 191 766.4 filed Nov. 18, 2010, the disclosure of which is incorporated by reference.

### BACKGROUND OF THE INVENTION

1. Field of the Invention

The invention relates to a laminate material element for a hook-and-loop closure, particularly for a diaper closure, having a carrier and a textile material laminated onto the carrier, which material has a basic structure formed from threads or fibers, and threads incorporated into the basic structure by knitting. The threads incorporated into the basic structure by knitting form loops for making a connection with hook-and-loop hooks. At least a part of the threads or fibers of the basic structure is formed from polyamide.

2. The Prior Art

According to their usual configuration, hook-and-loop closures consist of a loop part as well as a hook part. Corresponding hook-and-loop closures are also referred to as hook-and-loop systems. Hook-and-loop closures are used both for multiple use and for disposable articles such as diapers, particularly baby diapers or incontinence articles for adults.

In the case of diaper closures for disposable diapers, laminates composed of a printed polyethylene film as the carrier and a knitted fabric composed of polyamide laminated onto it with adhesive are generally used, in practice. Specifically in the case of disposable products such as diapers, low production costs overall and thus also low weights per surface area unit of the carrier and the textile material laminated onto it are aimed at, so that the textile material has an open and airy structure. In the case of such laminate material elements, the problem generally exists that this element must demonstrate sufficient stability at the lowest possible production costs. Gluing in the loops provided for making the connection with the hook-and-loop hooks must be avoided, because they are no longer available for making a connection with hook-and-loop hooks if they are glued in.

A laminate material element having a film as the carrier and a textile material is known from European Patent No. EP 0 777 006 B1, whereby the textile material has an interlaid scrim of weft and warp threads, as well as loops connected with the interlaid scrim by means of knitting technology. In order to be able to structure the textile material as light and open as possible, this material is laminated to the carrier film over its full area. Tensile forces that act on the loops are transferred directly to the carrier film, by way of the adhesive, and this film accordingly imparts the required strength to the entire laminate material element. In order to avoid inclusion of the loops in the case of full-area gluing, all the loops are dimensioned to be so large that they lie on the mesh formed by the basic interlaid scrim.

A fundamentally different approach is pursued in European Patent No. EP 1 579 779 B1, whereby it is proposed to connect a carrier film with a knitted textile material not over the full area, so that in addition to adhesive surfaces, regions free of adhesive are also present, in which the carrier film and the textile material lie loosely on one another. In these regions, the loops are accessible completely freely, and in part, hooking of the hook-and-loop hooks into the basic structure of the textile material is possible. In this way, an optimal hook-and-loop effect is observed in the regions free of adhesive. In contrast to the full-area gluing known from EP 0 777 006 B1, however, the textile material must demonstrate increased strength and stability, because in the regions free of adhesive, the tensile forces must first be transferred, by way of the textile material itself, all the way to the glued regions that follow at the edges. This increased strength must be guaranteed by means of a suitable selection of the threads that form the textile material. However, in total, good material properties, at low production costs, can be achieved by the saving in adhesive as well as the very good hook-and-loop effect in the regions free of adhesive. The textile material can be formed from polypropylene, polyester, or polyamide.

### SUMMARY OF THE INVENTION

It is an object of the present invention to provide a laminate material element having a carrier and a textile material laminated onto the carrier, which demonstrates an improved hook-and-loop effect, particularly in the glued regions. Furthermore, the laminate material element is cost-advantageous and suitable, in particular, for disposable articles.

This object is accomplished according to the invention, in that the threads incorporated into the basic structure by knitting have polyolefin, particularly polypropylene, as their main component.

The present invention therefore teaches using different materials, at least for part of the threads or fibers of the basic structure, on the one hand, and the threads incorporated into the basic structure by knitting, on the other hand. The different demands on the basic structure and on the loops provided for use with the hook-and-loop hooks, are taken into consideration. Thus, the basic structure must demonstrate great strength, and it must also be possible to easily laminate it to the carrier, which is preferably a film, by means of adhesive. Polyamide meets these requirements, because it not only has great strength but also, on the basis of its polarity, can be glued very well with an adhesive, for example a lamination adhesive on the basis of polyurethane. The fibers or threads of polyamide provided in the basic structure, according to the invention, guarantee a secure bond with the carrier, and great strength.

The present invention furthermore teaches using a different material for the threads knitted into the basic structure, which form loops provided for making a connection with the hook-and-loop hook, which has polyolefin, particularly polypropylene, as its main component. Main component means that the polyolefin component of the material amounts to at least 50 wt.-% and preferably at least 80 wt.-%. The corresponding thread can also consist entirely of polyolefin, particularly polypropylene. Polyolefins, particularly polypropylene, have no or only comparatively slight polarity, and therefore cannot be glued as easily, in most cases. This leads to the result that even in the case of full-area gluing or only partial gluing in the glued regions, the threads that form the loops are not glued in, or are glued in to a lesser degree, so that the hook-and-loop effect, as a whole, is significantly improved in the glued regions. Even if the loops are slightly glued in, they can also be released from the adhesive more easily when the laminate material element is used, or prior to that, in a separate method step, for example brushing, so that the loops are then available for making an effective connection with hook-and-loop hooks. In contrast to a textile material that is formed entirely from polyamide, significant cost savings are also obtained, because of the lower costs for polyolefins, including, in particular, polypropylene.

The basic structure of the textile material can be formed in different ways, within the scope of the invention. Fundamentally, it is possible to make available a nonwoven formed from fibers as the basic structure; this is then formed from polyamide fibers or a fiber mixture with a significant proportion of polyamide fibers. Preferably, however, the basic structure is woven, loom-knitted, or knitted. In the case of a woven or knitted basic structure, at least one thread type composed of polyamide is provided for taking part in the formation of the basic structure.

In the case of a woven basic structure with warp and weft threads, at least the warp threads or the weft threads consist of polyamide. A knitted basic structure can fundamentally be formed from one fiber type, i.e. plurality of threads that are processed according to the same lapping pattern. Preferably, in the case of a knitted basic structure, two thread types with different lapping patterns are provided. In this way, it is possible to adjust the strength and the other properties of the knitted textile material. The polyamide fibers have polyamide as their main component. In usual manner, however, additives, fillers, processing aids, pigments, coatings, or the like can also be provided, which have a weight proportion of less than 30%, preferably less than 15% of the total thread material.

In the case of a basic structure knitted from two thread types, wales form in the knitting direction, i.e. the production direction of the knitted fabric, and stitch courses form in the transverse direction. According to a preferred embodiment, a lapping pattern according to which this thread type connects at least two wales, particularly two adjacent wales, is provided for the first thread type. The threads of the second thread type extensively lie free between the wales, within the scope of such an embodiment, and therefore can also be glued well. In addition, the threads that run between the wales might be exposed to great tensile forces during use of the laminate material element, under some circumstances, so that these, specifically, must demonstrate great stability, and for this reason, polyamide, as a material with tensile strength, is particularly suitable for this first thread type. The second thread type, in contrast, can run precisely along a wale, in the knitting direction. Depending on the requirements and thread thickness, the second thread type described can then also be formed from cost-advantageous polyolefin, particularly polypropylene. However, if greater tensile strengths are required, the threads of the second thread type can also be formed from polyamide.

In the case of a woven or knitted basic structure, fundamentally mono-filament threads and/or multi-filament threads can be used. In the case of the knitted basic structure described above, with a first thread type that connects at least two stitch courses, and a second thread type, it proves to be particularly advantageous if the first thread type is made available as a mono-filament thread, and/or if the threads that form the loops are multi-filament threads. Multi-filament threads are particularly suitable for making a connection with hook-and-loop hooks, because a certain hook-and-loop effect is already achieved if hook-and-loop hooks engage under only some of the filaments. Specifically in the case of loops that run freely, a clearly softer surface is also obtained in the case of a multi-filament thread. Finally, it must be taken into consideration that when using the laminate material element as a diaper closure, only a limited number of opening and closing processes are provided. Therefore, if some of the filaments on a loop tear during an opening process, some of the filaments of the multi-filament thread still remain there, and this can be used for a further connection. The threads of the second thread type can optionally be configured as multi-filament threads or mono-filament threads.

Within the scope of the invention, aside from a usual film, a nonwoven material is fundamentally also possible as the carrier, whereby the carrier is frequently printed with a decorative pattern that is then visible through the textile material that is laminated on. If the carrier is formed from a single-layer or multi-layer film, this preferably has a polyolefin, particularly polyethylene, as the main component on the surface that is laminated to the textile material. A cost-advantageous single-layer or multi-layer polyethylene film is particularly preferred.

Within the scope of the present invention, both full-area gluing and partial-area gluing can take place, whereby then, an improved hook-and-loop effect is achieved in the glued regions, because the loops there are glued to a lesser degree, because of the polyolefin material, particularly polypropylene, that is used. The basic structure with at least a proportion of threads composed of polyamide guarantees great stability and lamination strength, so that fundamentally, even gluing only over a portion of the area is sufficient, as described in EP 1 579 779 B1 and EP 1 690 967 B1 the disclosures of which are herein incorporated by reference. The measures described there can also be used, without restrictions, within the scope of the present invention, so that then, the adhesive is applied in a pattern that is composed of adhesive areas and regions free of adhesive. In particular, according to EP 1 579 779 B1 and EP 1 690 967 B1, adhesive patterns with continuous lines and adhesive-free cells disposed between them can be formed. It is also possible to provide an essentially rectangular lattice pattern, whereby then, individual wales are not attached, or only attached at intersecting adhesive strips, in connection with the knitted textile material.

When adhesive is applied not over the full area, the proportion of the glued surface typically amounts to between 10% and 40%, preferably between 14% and 28% of the total area. Usual lamination adhesives, particularly adhesives on the basis of polyurethane, are suitable.

The textile material, which should be as light as possible, for cost reasons, but nevertheless must demonstrate sufficient stability and hook-and-loop effect, preferably has a weight per surface area unit between 10 g/m² and 40 g/m², preferably between 14 g/m² and 28 g/m².

If a film is used as the carrier, this can usually be structured to be relatively thin, because it is essentially provided for the purpose of being able to handle the laminate material element easily and to apply it, for example, in the waist region of a diaper. The thickness of the film, which preferably consists of polyolefin, particularly polyethylene, can lie between 10 μm and 40 μm, particularly between 15 μm and 25 μm, for example.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a longitudinal section through a laminate material for hook-and-loop closures, according to the invention,

FIG. 2 shows a lapping pattern for a textile material of the laminate material element, produced by means of knitting technology, and

FIG. 3 shows the finished textile material produced according to the lapping pattern according to FIG. 2.

### DETAILED DESCRIPTION OF THE PREFERRED EMBODIMENT

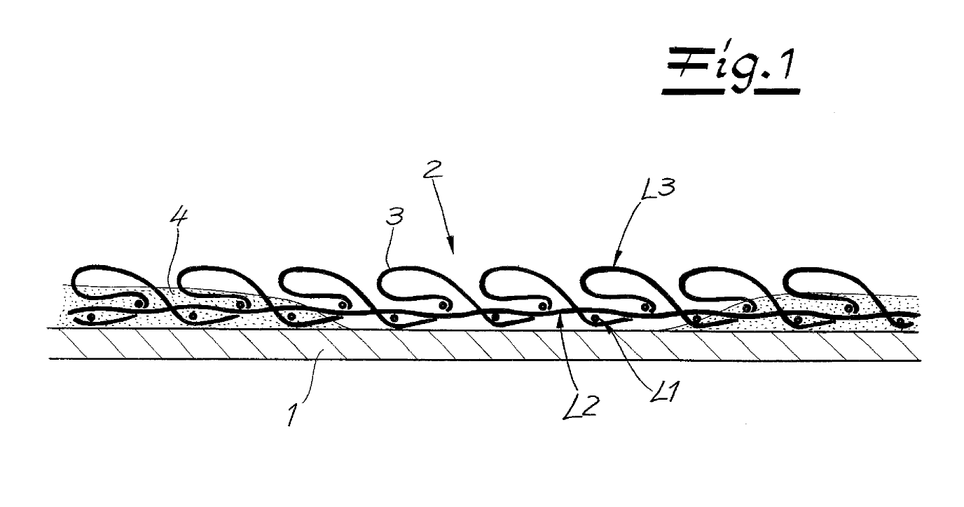

Referring now in detail to the drawings, FIG. 1 shows a laminate material element for hook-and-loop closures, particularly for a diaper closure, having a carrier 1 and a textile material 2 laminated onto the carrier 1, which material has a basic structure formed from threads L1, L2 and threads L3 incorporated into the basic structure by knitting. Threads L3 incorporated into the basic structure by knitting form loops 3 provided for making a connection with hook-and-loop hooks.

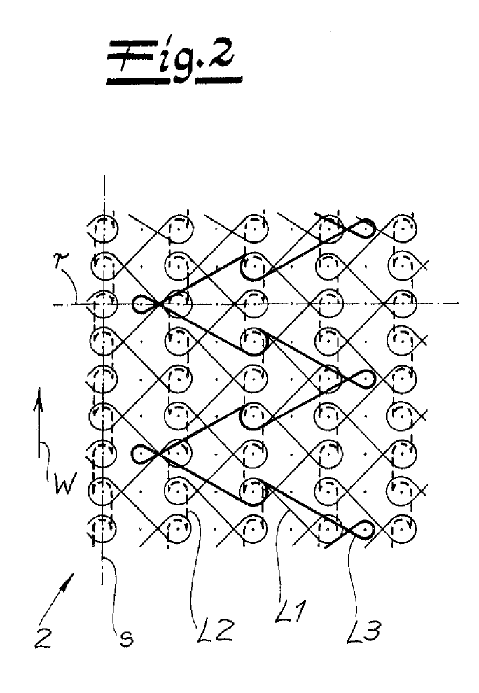

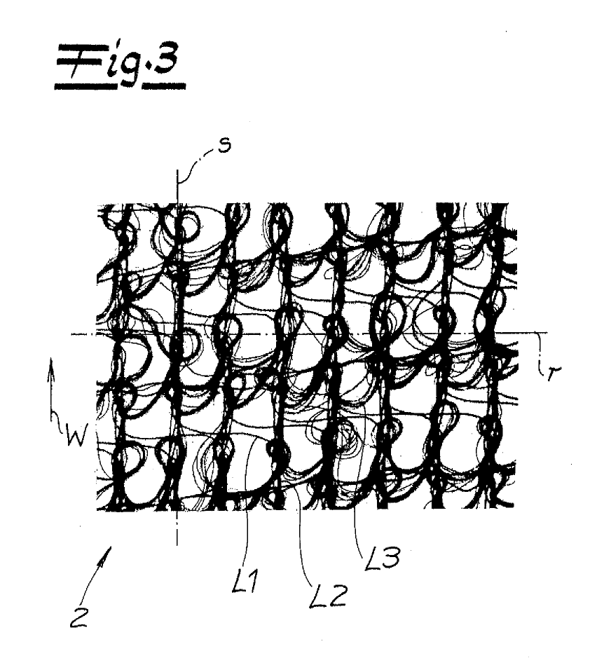

The representation of FIG. 1 shows threads L1, L2 that form the basic structure, as well as threads L3 that form the loops, in greatly simplified manner. Thus, threads L1, L2, L3 do not run precisely in the knitting direction or transverse to it in the case of a knitted basic structure, but rather, they are meshed with one another according to a predetermined lapping pattern, thereby resulting in reciprocal looping of threads L1, L2, L3 around one another at the individual stitches. This circumstance becomes clear from FIGS. 2 and 3, which show an exemplary lapping pattern for a knitted textile material, as well as the corresponding textile material itself.

According to the invention, at least one of the threads L1 of the basic structure is formed from polyamide as the essential component, while thread L3 that forms the loops has polyolefin, particularly polypropylene, as its main component. In the lamination of textile material 2 with carrier 1 by means of adhesive 4, particularly an adhesive 4 on the basis of polyurethane, as shown in FIG. 1, threads L1, L2 of the basic structure are securely connected with carrier 1, while the first threads L1 or first thread type composed of polyamide, in particular, can be glued very well, because of its polarity.

In FIG. 1, an embodiment is shown, as an example, in which the adhesive application takes place not over the full area. Here, the basic structure and, in particular, the comparatively stable thread L1 composed of polyamide guarantee great strength. The forces that act in the regions that are not glued, during use of the laminate material element, can be transferred to the glued regions by way of the sufficiently stable basic structure.

FIG. 2 shows, as an example, a lapping pattern for the textile material 2 of the laminate material element. The entire textile material 2 is formed from three thread types, i.e. from three threads that are passed over the needles of a knitting machine in different ways and that recur regularly in the transverse direction. The basic structure is knitted from a first thread type L1 and a second thread type L2. Wales s form in the knitting direction W, i.e. the production direction, and stitch courses r form in the transverse direction. The first thread L1, i.e. the first thread type, is knitted in such a manner that it connects two adjacent wales s, whereby thread L1 is passed back and forth from stitch course r to stitch course r. The first thread type L1, which imparts stability in the transverse direction to textile material 2, consists of polyamide, for example PA6.

The second thread L2 or the second thread type of the basic structure is guided precisely along one of the wales s in each instance in the knitting direction W. Depending on the requirements, this second thread L2 can be formed from polyamide or a polyolefin, particularly polypropylene. While improved strength and lamination adhesion are obtained in the case of a configuration composed of polyamide, a configuration composed of polypropylene allows a reduction in the overall costs.

The third thread L3 or thread type is incorporated into the basic structure and forms free loops 3. The loops are produced in that a free loop head is formed between two loop feet looped onto a wale s, in each instance, which head is not meshed together with the other threads L1, L2 during the knitting process. After the knitting process, loop 3 formed in this manner can stand up and connect with hook-and-loop hooks. Because the material of the thread L3 that forms loops 3 is less strongly fixed in place when using usual lamination adhesives, the hook-and-loop effect is improved in the glued regions. As a comparison, a knitted fabric having a weight per surface area unit of 18 g/m², formed entirely from PA6, according to the state of the art, and of PA6 threads and polypropylene threads, having a weight per surface area unit of the textile material of about 15 g/m² according to the invention, were laminated onto a lamination film of polyethylene, having a thickness of 18 μm. The lamination took place by means of gluing in a rectangular adhesive pattern, with a coverage of adhesive of 23%. In the case of the laminate material element according to the invention, the first thread type L1, proceeding from a knitted pattern according to FIG. 2, consists of polyamide 6 (PA6) threads, while the other threads L2, L3 consist of polypropylene. Taking into consideration the thread thicknesses used, the total weight proportion of polyamide in the textile material 2 was 30% as compared with 70% polypropylene. To check the hook-and-loop effect, the peelability and the peel strength were tested, whereby test methods according to ASTM D5170-91 (shear/peel test) and ASTM D5169-91 (dyn. shear test) were carried out. Hooks of the “3M CHK 01088” type were used as the hook material. The tests show that it was possible to increase the maximal force determined for peeling, in the configuration according to the invention, by about 70% as compared with the state of the art.

Accordingly, while only a few embodiments of the present invention have been shown and described, it is obvious that many changes and modifications may be made thereunto without departing from the spirit and scope of the invention.

What is claimed is:

1. A laminate material element for a hook-and-loop closure, particularly for a diaper closure, comprising:
a carrier;
a textile material laminated onto the carrier, said textile material having a basic structure formed from threads or fibers, with additional threads incorporated into the basic structure by knitting, wherein the additional threads incorporated into the basic structure by knitting form loops provided for making a connection with hook-and-loop hooks, wherein at least a part of the threads or fibers of the basic structure is formed from polyamide, and wherein the additional threads have polyolefin as a main component.

2. The laminate material element according to claim 1, wherein the basic structure is woven or knitted, and wherein at least one thread type that forms the basic structure is formed from polyamide.

3. The laminate material element according to claim 2, wherein the basic structure is composed of a first thread type and a second thread type and wherein the basic structure has wales in a knitting direction and stitch courses in a transverse direction, and wherein the first thread type is knitted in such a manner that the first thread type connects at least two wales.

4. The laminate material element according to claim 3, wherein the threads of the second thread type run precisely along each of the wale, in the knitting direction.

5. The laminate material element according to claim 1, wherein the carrier is a film.

6. The laminate material element according to claim 5, wherein the film that forms the carrier has polyolefin as a main component, at least at a surface that is laminated to the textile material.

7. The laminate material element according to claim 1, wherein the carrier and the textile material are connected by an adhesive, not over their full area.

8. The laminate material element according to claim 7, wherein the adhesive is disposed in a pattern that is composed of adhesive surfaces and regions free of adhesive.

9. The laminate material element according to claim 7, wherein a proportion of the glued surface of the carrier and textile material amounts to 10% to 40% of the total area.

10. The laminate material element according to claim 1, wherein the carrier and the textile material are laminated using an adhesive comprising polyurethane.

11. The laminate material element according to claim 1, wherein the textile material has a weight per surface area unit between 10 g/m² and 40 g/m².
